(19) United States
(12) Patent Application Publication
(10) Pub. No.: US 2019/0288852 A1
(43) Pub. Date: Sep. 19, 2019

(54) PROBABILISTIC DEVICE IDENTIFICATION

(71) Applicant: CA, Inc., Islandia, NY (US)

(72) Inventors: Atmaram Prabhakar Shetye, Bangalore (IN); Himanshu Ashiya, Bangalore (IN); Ravi Garg, Bangalore (IN)

(21) Appl. No.: 15/922,275

(22) Filed: Mar. 15, 2018

(51) Int. Cl. H04L 9/32; G06F 17/30; G06N 7/00; G06N 5/04

(52) U.S. Cl. CPC H04L 9/3247; G06F 17/30536; G06Q 20/388; G06N 7/005; G06N 5/047; G06F 17/3053

(57) ABSTRACT

In one embodiment, a transaction associated with a first device is identified. Based on the transaction, a first device signature for the first device is determined. A plurality of known device signatures associated with a plurality of known devices is accessed. A plurality of signature transition features between the plurality of known device signatures and the first device signature is identified, wherein each signature transition feature comprises a transition from an attribute of a known device signature to a corresponding attribute of the first device signature. A classification model is then applied to the plurality of signature transition features. Based on an output of the classification model, a plurality of device match probabilities indicating whether the first device is one of the plurality of known devices is obtained. The identity of the first device is then determined based on the plurality of device match probabilities.

### BACKGROUND

This disclosure relates in general to the field of computing systems, and more particularly, though not exclusively, to device identification in a computing system.

In some cases, for example, it may be desirable to identify a user of a computing system and/or a device associated with that user. Accordingly, in some cases, a computing system may leverage cookies for user and/or device identification purposes. In some circumstances, however, cookies may be unavailable or unreliable, thus rendering it challenging to identify a user and/or a device associated with the user.

### BRIEF SUMMARY

According to one aspect of the present disclosure, a transaction associated with a first device is identified. Based on the transaction, a first device signature for the first device is determined. A plurality of known device signatures associated with a plurality of known devices is accessed. A plurality of signature transition features between the plurality of known device signatures and the first device signature is identified, wherein each signature transition feature comprises a transition from an attribute of a known device signature to a corresponding attribute of the first device signature. A classification model is then applied to the plurality of signature transition features. Based on an output of the classification model, a plurality of device match probabilities indicating whether the first device is one of the plurality of known devices is obtained. The identity of the first device is then determined based on the plurality of device match probabilities.

### BRIEF DESCRIPTION OF THE DRAWINGS

FIG. 1 illustrates an example embodiment of a computing system in accordance with certain embodiments.

FIG. 2 illustrates an example embodiment of a device identification system.

FIG. 3 illustrates an example of user agent tokenization for device identification.

FIGS. 4A-H illustrate an example of probabilistic device identification.

FIG. 5 illustrates a flowchart for an example embodiment of device identification.

### DETAILED DESCRIPTION OF EXAMPLE EMBODIMENTS

As will be appreciated by one skilled in the art, aspects of the present disclosure may be illustrated and described herein in any of a number of patentable classes or contexts, including any new and useful process, machine, manufacture, or composition of matter, or any new and useful improvement thereof. Accordingly, aspects of the present disclosure may be implemented entirely as hardware, entirely as software (including firmware, resident software, micro-code, etc.), or as a combination of software and hardware implementations, all of which may generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain or store a program for use by, or in connection with, an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, CII, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on a user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider), or in a cloud computing environment, or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses, or other devices, to produce a computer implemented process such that the instructions which execute on the computer or other programmable apparatus provide processes for implementing the functions/acts specified in the flowchart and/or block diagram block or blocks.

Example embodiments that may be used to implement the features and functionality of this disclosure will now be described with more particular reference to the attached FIGURES.

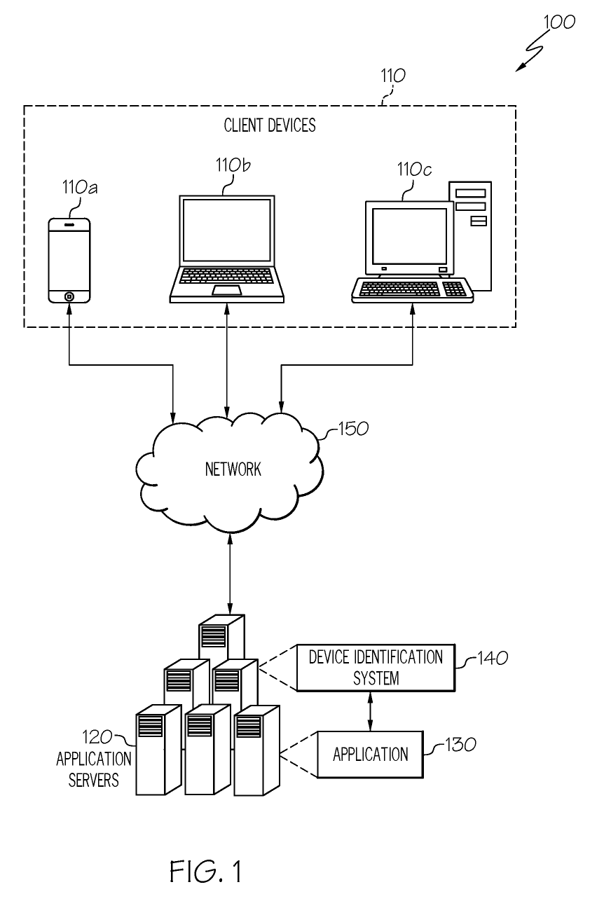

FIG. 1 illustrates an example embodiment of a computing system 100 in accordance with certain embodiments. In some embodiments, computing system 100 may include functionality for probabilistically determining the identity of devices 110 in computing system 100.

In the illustrated embodiment, for example, a variety of client devices 110a-c (e.g., mobile devices, laptops, desktops) may be interacting with an application 130 over a network 150. Application 130 may include any type of software that is hosted and/or deployed in computing environment 100, such as a web-services application hosted on one or more application servers 120. Moreover, in some cases, application 130 may need to authenticate incoming transactions from users of client devices 110, which may include authenticating the respective users and/or determining whether client devices 110 are known devices of those users. Accordingly, in some cases, cookies may be used to identify the users and/or client devices 110 associated with incoming transactions received by application 130. For example, after initially authenticating a particular user and/or client device 110, application 130 may provide an HTTP cookie to the client device 110, which may be used as a session and/or device identifier for subsequent transactions. In this manner, application 130 can use cookies to identify the users and/or client devices 110 associated with incoming transactions.

In some cases, however, cookies may be unavailable or unreliable, as they may be unsupported, disabled, deleted, and/or spoofed by a particular client device 110. Moreover, when cookies are unavailable or unreliable, it may be challenging to identify a particular client device 110 and/or determine whether the client device 110 is a known device of an associated user. Accordingly, in some cases, a client device 110 may be identified using probabilistic device identification functionality. In the illustrated embodiment, for example, computing system 100 includes a device identification system 140 that can be used (e.g., by application 130) to probabilistically identify a client device 110 and/or determine whether the device 110 is a known device of an associated user, as described further below and throughout this disclosure. In various embodiments, the functionality of device identification system 140 may be implemented by any component and/or combination of components in a computing system, including as a standalone component of a computing system, and/or as functionality integrated into existing components of a computing system, such as application servers 120 and/or application 130 of computing system 100.

In the illustrated embodiment, device identification system 140 may be used to probabilistically identify a device 110 based on its signature or fingerprint. A signature or fingerprint of a device 110, for example, may be generated based on various characteristics or attributes of the device 110, such as its user agent, IP address, language preferences, time zone, JavaScript parameters (e.g., screen size), and so forth. For example, a “user agent” may refer to software and/or hardware that is used to interact on behalf of a user. Moreover, in web-based contexts, a client device 110 often provides a user agent string or header to a server application 120 to identify the underlying software and/or hardware of the client device 110, such as its browser, platform, operating system, processor, plugins, extensions, associated version numbers, and so forth. Accordingly, in some embodiments, a device signature or fingerprint may be generated for a client device 110 based on its associated user agent and/or any other attributes. In this manner, device signatures may be used to determine whether incoming transactions are originating from known devices 110 of the respective users.

In some embodiments, for example, device signatures may be generated and stored for all known devices 110 of a particular user, such as devices 110 that have been identified previously for the user via cookies or any other means. Moreover, when a new incoming transaction associated with the user is received, a device signature for the incoming transaction can be generated and matched against the stored signatures for known devices 110 of the user. If the incoming device signature is deemed to be a match of a known device signature, it may be assumed that the incoming transaction is originating from the known device corresponding to the matching signature. On the other hand, if the incoming device signature is deemed not to match any of the known device signatures, it may be assumed that incoming transaction is originating from a new or unknown device.

In some embodiments, for example, device signature matching could be implemented using an “exact match” approach. For example, the incoming device signature could be compared to known device signatures to determine if the incoming signature is an exact match of any of the known signatures. An exact match approach is often inflexible, however, as it may be unable to accommodate variations in the device signature of the same device 110 over time. For example, the user agent of a particular device 110 often changes or varies over time, such as in response to software upgrades (e.g., resulting in updated version numbers), configuration changes, plugin or extension installations, and so forth. Accordingly, an exact match approach may result in false-negatives for incoming transactions from known devices whose signatures have changed, even if only slightly.

Alternatively, in some embodiments, device signature matching could be implemented using a distance comparison or “diff” approach. For example, a distance or “diff” could be computed between the incoming device signature and each known device signature (e.g., based on a ratio of matching/non-matching characters), and a particular known signature may be deemed a match if it has no or minimal differences relative to the incoming signature. This type of approach can be inaccurate, however, as it may produce false-positives for different devices 110 with similar signatures, and/or false-negatives for a single device 110 with a signature that has changed beyond a certain extent.

Accordingly, in some embodiments, device signature matching may be implemented using a probabilistic classification model that accommodates device signature variations without sacrificing accuracy. For example, in some embodiments, device identification system 140 may implement device signature matching using a probabilistic classifier, such as a naïve Bayes classifier. The probabilistic classifier may first be trained using stored signatures for known devices of a particular user, and it may subsequently be used to determine whether new or incoming transactions for that user are originating from one of those known devices. In this manner, the probabilistic classifier enables “fuzzy” matching of device signatures with high accuracy, thus accommodating variations in device signatures that result from software upgrades, configuration changes, and so forth. Additional details and embodiments are described throughout this disclosure in connection with the remaining FIGURES.

In general, elements of computing system 100, such as “systems,” “servers,” “services,” “hosts,” “devices,” “clients,” “networks,” “computers,” and any components thereof, may be used interchangeably herein and refer to computing devices operable to receive, transmit, process, store, or manage data and information associated with computing system 100. Moreover, as used in this disclosure, the term “computer,” “processor,” “processor device,” or “processing device” is intended to encompass any suitable processing device. For example, elements shown as single devices within computing system 100 may be implemented using a plurality of computing devices and processors, such as server pools comprising multiple server computers. Further, any, all, or some of the computing devices may be adapted to execute any operating system, including Linux, other UNIX variants, Microsoft Windows, Windows Server, Mac OS, Apple iOS, Google Android, etc., as well as virtual machines adapted to virtualize execution of a particular operating system, including customized and/or proprietary operating systems.

Further, elements of computing system 100 (e.g., client devices 110, application servers 120, device identification system 140, network 150 etc.) may each include one or more processors, computer-readable memory, and one or more interfaces, among other features and hardware. Servers may include any suitable software component or module, or computing device(s) capable of hosting and/or serving software applications and services, including distributed, enterprise, or cloud-based software applications, data, and services. For instance, one or more of the described components of computing system 100, may be at least partially (or wholly) cloud-implemented, “fog”-implemented, web-based, or distributed for remotely hosting, serving, or otherwise managing data, software services, and applications that interface, coordinate with, depend on, or are used by other components of computing system 100. In some instances, elements of computing system 100 may be implemented as some combination of components hosted on a common computing system, server, server pool, or cloud computing environment, and that share computing resources, including shared memory, processors, and interfaces.

The network(s) 150 used to communicatively couple the components of computing system 100 may be implemented using any suitable computer communication network technology to facilitate communication between the participating components. For example, one or a combination of local area networks, wide area networks, public networks, the Internet, cellular networks, Wi-Fi networks, short-range networks (e.g., Bluetooth or ZigBee), and/or any other wired or wireless communication medium may be utilized for communication between the participating devices, among other examples.

While FIG. 1 is described as containing or being associated with a plurality of elements, not all elements illustrated within computing system 100 of FIG. 1 may be utilized in each alternative implementation of the embodiments of this disclosure. Additionally, one or more of the elements described in connection with the examples of FIG. 1 may be located external to computing system 100, while in other instances, certain elements may be included within or as a portion of one or more of the other described elements, as well as other elements not described in the illustrated implementation. Further, certain elements illustrated in FIG. 1 may be combined with other components, as well as used for alternative or additional purposes in addition to those purposes described herein.

Additional embodiments and functionality associated with the implementation of computing system 100 are described further in connection with the remaining FIGURES. Accordingly, it should be appreciated that computing system 100 of FIG. 1 may be implemented with any aspects or functionality of the embodiments described throughout this disclosure.

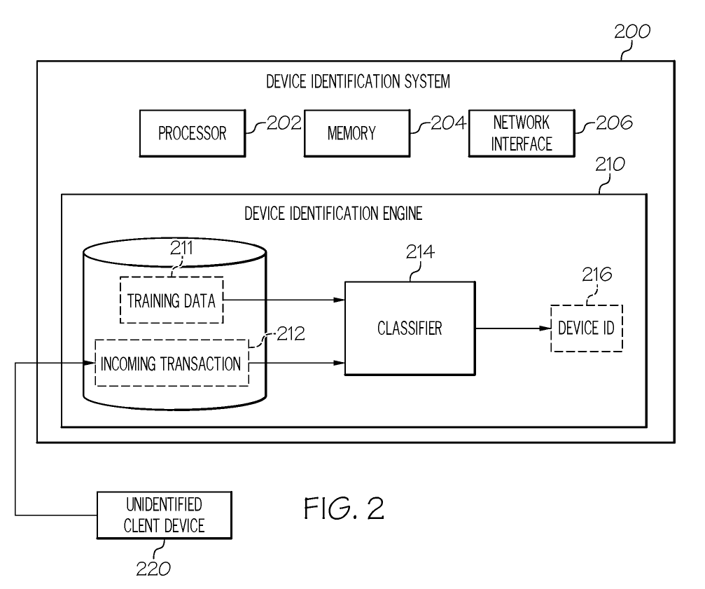

FIG. 2 illustrates an example embodiment of a device identification system 200 for identifying devices in a computing system. In some embodiments, for example, device identification system 200 may be used to implement the functionality of device identification system 140 of FIG. 1 (e.g., for identifying client devices 110 in computing system 100 of FIG. 1).

In the illustrated embodiment, device identification system 200 includes one or more processors 202, memory elements 204, and network interfaces 206, along with a device identification engine 210. In some implementations, the various illustrated components of device identification system 200, and/or any other associated components, may be combined, or even further divided and distributed among multiple different systems. For example, in some implementations, device identification system 200 may be implemented as multiple different systems with varying combinations of the foregoing components (e.g., 202, 204, 206, 210). Components of device identification system 200 may communicate, interoperate, and otherwise interact with external systems and components (including with each other in distributed embodiments) over one or more networks using network interface 206.

Device identification engine 210 may implement the probabilistic device identification functionality described throughout this disclosure. Moreover, in some embodiments, device identification engine 210 and/or its underlying components may be implemented using machine executable logic embodied in hardware- and/or software-based components. In some cases, for example, a server or host application may need to authenticate an incoming transaction 212 from a user of a client device 220, which may include authenticating the user and/or determining whether client device 220 is a known device of that user. Accordingly, in the illustrated embodiment, device identification engine 210 includes functionality for probabilistically identifying a client device 220 based on a device signature or fingerprint. In this manner, device identification engine 210 can be used to determine whether client device 220 is a known device of the associated user.

In some embodiments, for example, a signature or fingerprint of a client device may be generated based on various characteristics or attributes of the device, such as its user agent, IP address, language preferences, time zone, JavaScript parameters (e.g., screen size), and so forth. For example, in some cases (e.g., client-server and/or web-based contexts), a client device may provide a user agent string or header to a server or host application to identify the underlying software and/or hardware of the client device, such as its browser, platform, operating system, processor, plugins, extensions, associated version numbers, and so forth. A signature or fingerprint for the client device can then be generated based on the associated user agent information, along with any other attributes of the client device.

Accordingly, in some embodiments, device identification engine 210 may first collect device signatures for all known devices of a particular user. In some embodiments, for example, device signatures may be generated and stored based on past transactions of a user that originate from known devices, such as devices whose identities were independently verified via cookies or any other means. In this manner, when a new incoming transaction 212 associated with the user is received from an unidentified or unverified client device 220, a device signature for the unidentified device 220 can be generated based on attributes derived from the incoming transaction 212, and the unidentified device 220 can then be matched against the known devices based on the respective device signatures. If unidentified device 220 is deemed to be a match of a particular known device, it may be assumed that incoming transaction 212 is originating from the particular known device. On the other hand, if unidentified device 220 is deemed not to match any of the known devices, it may be assumed that incoming transaction 212 is originating from a new or unknown device.

In some embodiments, for example, device identification may be implemented by remodeling a typical document classification problem, where the multi-class problem is converted into a two-class problem with match and non-match classes, the entire data set is used for each class, transitions between device attributes are used as features instead of words, and a threshold is used to accept or reject potential matches (e.g., thus accommodating new classes). In this manner, better features can be discovered by analyzing misclassifications.

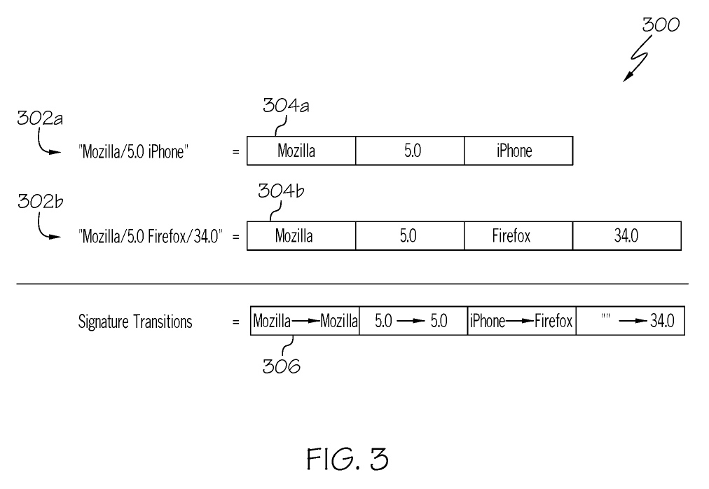

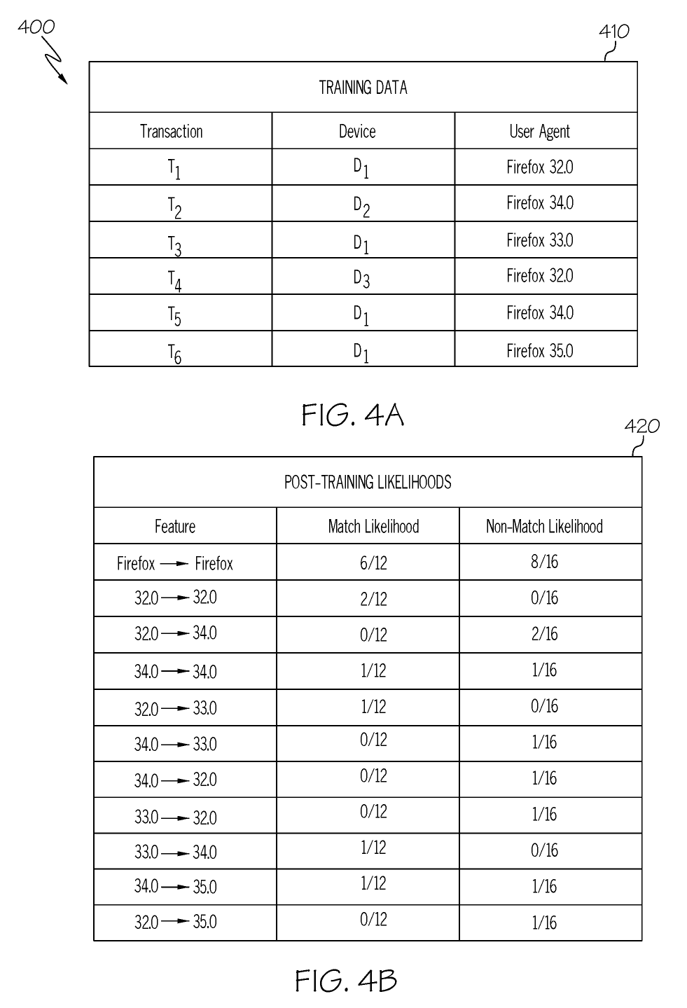

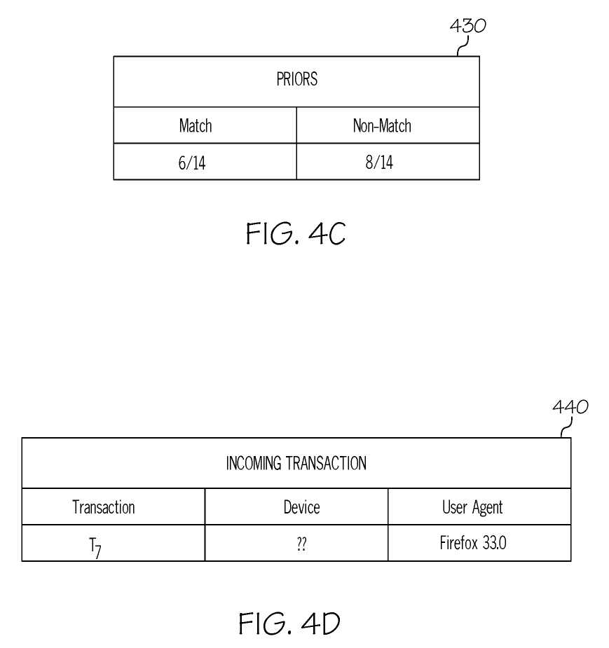

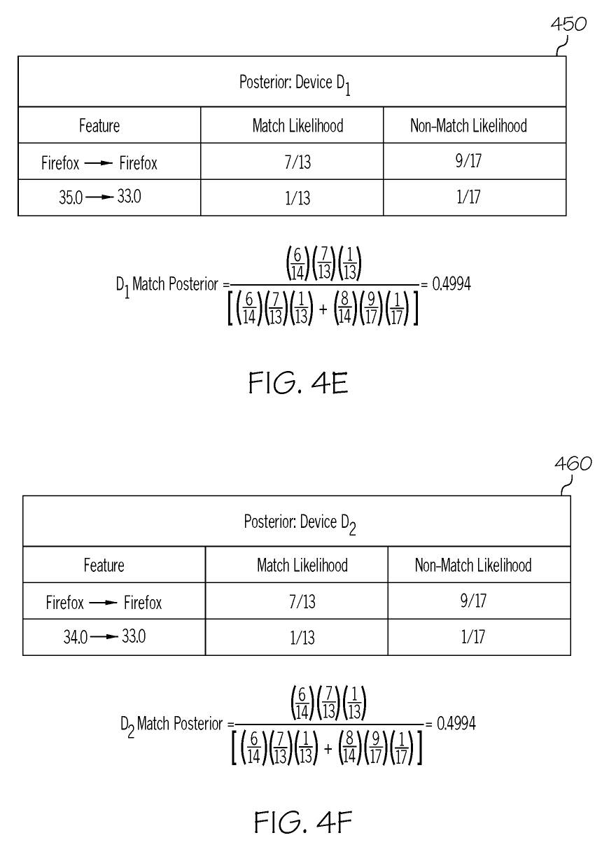

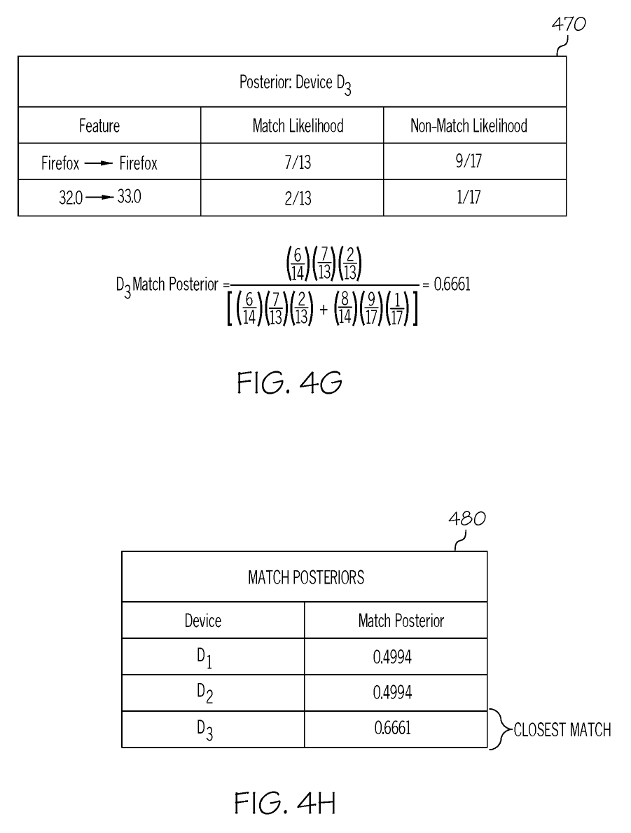

In the illustrated embodiment, for example, device identification engine 210 implements the device signature matching functionality using a classification model implemented by classifier 214. In some embodiments, for example, classifier 214 may be a probabilistic classifier such as a naïve Bayes classifier, or any other standard classifier. Classifier 214 may first be trained using training data 211, which may contain data associated with past transactions from known devices of a particular user (e.g., devices whose identities were independently verified via cookies or any other means). In some embodiments, for example, training data 211 may contain the following information for each past transaction of the user: (1) the identity of the corresponding known device, and (2) device attributes associated with the corresponding known device, such as its user agent. Moreover, a device signature can be generated for each past transaction using the corresponding device attributes obtained from the transaction, such as the user agent. For example, in some embodiments, the user agent may be represented as a string that contains attributes of the user agent, such as its browser, platform, operating system, processor, plugins, extensions, associated version numbers, and so forth. Accordingly, a device signature can be generated by tokenizing the attributes contained in the user agent string (e.g., as described further in connection with FIGS. 3 and 4A-H).

In this manner, a device signature can be generated for each past transaction contained in training data 211 based on the user agent and/or any other associated device attributes. Based on the resulting device signatures generated from the past transactions, signature transition features can then be defined between corresponding attributes of the known device signatures. A signature transition feature, for example, may identify a transition from an attribute of one known device signature to a corresponding attribute of another known device signature (e.g., as described further in connection with FIGS. 3 and 4A-H).

Classifier 214 can then train a probabilistic classification model (e.g., a naïve Bayes classification model) using the signature transition features as training input. In some embodiments, for example, classifier 214 may define two classes, a match class and a non-match class. Classifier 214 may then be trained using the signature transition features as input, and based on the training, classifier 214 may output a match likelihood and a non-match likelihood for each signature transition feature. Classifier 214 may also calculate a Bayesian prior probability for both the match class and the non-match class.

Once classifier 214 has been trained, it may be used to probabilistically determine whether a new or incoming transaction 212 from an unidentified device 220 is originating from one of the known devices of the particular user. In some embodiments, for example, classifier 214 may first generate a signature for unidentified device 220 based on device attributes identified from the incoming transaction 212, such as the user agent of unidentified device 220. Classifier 214 may then identify device match probabilities for the various known devices by computing a corresponding Bayesian match posterior for each known device. For example, for each known device, the most recent signature for the known device may be identified from training data 211, and signature transition features may then be identified between the known device signature and the unidentified device signature. Classifier 214 may then apply the probabilistic classification model to the signature transition features in order to identify a device match probability for the particular known device. In some embodiments, for example, classifier 214 may identify a match likelihood and a non-match likelihood for each signature transition feature. Classifier 214 may then calculate a Bayesian match posterior for the particular known device based on: (1) the Bayesian prior probabilities for the match and non-match classes computed during the training phase; and (2) the match and non-match likelihoods for the signature transition features between the known device signature and the unidentified device signature. In this manner, the resulting Bayesian match posterior indicates a probability of whether unidentified device 220 is the particular known device. In some embodiments, the log of probabilities may be used instead of direct probabilities to avoid underflow, and a Laplacian correction may be applied to avoid probabilities of zero.

Accordingly, classifier 214 may compute a Bayesian match posterior for each known device, and the resulting match posteriors may be used as device match probabilities for the known devices. For example, each Bayesian match posterior may represent a device match probability indicating whether unidentified device 220 is one of the known devices. In this manner, the known device with the highest device match probability is the closest match to unidentified device 220. Thus, in some embodiments, it may be determined that unidentified device 220 is the known device with the highest device match probability. Alternatively, the highest device match probability may first be compared to a threshold. If the highest device match probability exceeds the threshold, then it may be determined that unidentified device 220 is the corresponding known device. If the highest device match probability is below the threshold, however, then it may be determined that unidentified device 220 is not any of the known devices, and instead is an unknown or new device. In some embodiments, the threshold may be optimized during the training stage using a cross-validation dataset to identify an optimal threshold value.

In this manner, classifier 214 provides “fuzzy” device signature matching with high accuracy using a probabilistic approach, thus accommodating variations in device signatures that result from software upgrades, configuration changes, and so forth, and further providing the ability to learn or adapt to new types and trends of upgrades.

FIG. 3 illustrates an example 300 of user agent tokenization for device identification. In some embodiments, for example, user agents may be tokenized in order to generate device signatures or fingerprints, and transitions between corresponding attributes of the device signatures may then be used for device identification purposes, as described further throughout this disclosure.

In some embodiments, for example, a user agent associated with a device may be represented as a string that contains attributes of the user agent, such as its browser, platform, operating system, processor, plugins, extensions, associated version numbers, and so forth. In client-server and/or web-based contexts, for example, a user agent may be represented as a string with the following format or a variation thereof:

“[product]/[version] ([system and browser information]) [platform] ([platform details]) [extensions]”.

Accordingly, in some embodiments, the user agent may be used to generate a device signature or fingerprint by treating the user agent string as free text and tokenizing the text based on whitespaces (‘ ’) and slashes (‘/’). Further, in some cases, tokens that likely contain version numbers may be further split if they contain more than two version number components. For example, if a token contains two or more period (‘.’) characters, it may be assumed that the token represents a version number with more than two version number components, and thus the token may be further split into bigrams. For example, a token containing version number “X.Y.Z” may be split into bigrams, thus resulting in two separate tokens “X.Y” and “Y.Z”.

To illustrate, the following is an example of a user agent string provided by the Safari browser on an iPhone, along with the corresponding token vector generated using the tokenization approach described above:
USER AGENT: “Mozilla/5.0 (iPhone; CPU iPhone OS 10_0_2 like Mac OS X) AppleWebKit/602.1.50 (KHTML, like Gecko) Version/10.0 Mobile/14A456 Safari/602.1”
TOKEN VECTOR: [Mozilla, 5.0, (iPhone; CPU, iPhone, OS, 10_0_2, like, Mac, OS, X), AppleWebKit, 602.1, 1.50, (KHTML, like, Gecko), Version, 10.0, Mobile, 14A456, Safari, 602.1]

Turning to the illustrated example 300 of FIG. 3, user agents 302a,b are strings that each contain attributes associated with a particular user agent of a device. For the sake of simplicity, a simplified format is used for user agent strings 302a,b in this example. In the illustrated example 300, user agents 302a,b are first tokenized in order to generate corresponding device signatures 304a,b. For example, user agents 302a,b are each split into tokens separated by the whitespaces (‘ ’) and slashes (‘/’) in the respective strings, the resulting tokens for each user agent 302a,b are then stored in token vectors, and the resulting token vectors for user agents 302a,b are then used to represent the corresponding device signatures 304a,b:

| | DEVICE SIGNATURE/ | | | |
|---|---|---|---|---|
| USER AGENT | TOKEN VECTOR | | | |
| “Mozilla/5.0 iPhone” = | Mozilla | 5.0 | iPhone | |
| “Mozilla/5.0 Firefox/34.0” = | Mozilla | 5.0 | Firefox | 34.0 |

Next, signature transitions 306 can then be identified between corresponding tokens or attributes of device signatures 304a,b, using empty strings as padding to address any size mismatches resulting from signatures with different numbers of tokens:

SIGNATURE TRANSITIONS

| | | | |
|---|---|---|---|
| Mozilla→Mozilla | 5.0→5.0 | iPhone→Firefox | “”→34.0 |

The signature transitions 306 derived using this approach can then be used for device identification purposes, as described further throughout this disclosure. Moreover, this approach can similarly be applied to other device attributes beyond those obtained from the user agent, such as an IP address, language preferences, time zone, JavaScript parameters (e.g., screen size), and so forth.

FIGS. 4A-H illustrate an example 400 of probabilistic device identification. In some embodiments, the probabilistic device identification functionality illustrated by example 400 may be implemented using the embodiments described throughout this disclosure, such as device identification system 200 of FIG. 2.

FIG. 4A illustrates example training data 410 associated with past transactions of a particular user:

TRAINING DATA

| Transaction | Device | User Agent |
|---|---|---|
| T₁ | D₁ | Firefox 32.0 |
| T₂ | D₂ | Firefox 34.0 |
| T₃ | D₁ | Firefox 33.0 |
| T₄ | D₃ | Firefox 32.0 |
| T₅ | D₁ | Firefox 34.0 |
| T₆ | D₁ | Firefox 35.0 |

For example, training data 410 contains data associated with past transactions T₁-T₆ of a particular user that originated from known devices D₁-D₃ of that user. In some embodiments, for example, the identities of known devices D₁-D₃ may have been independently verified via cookies or any other means. Moreover, for each past transaction T₁-T₆, training data 410 contains the identity of the associated device D₁-D₃, along with the corresponding user agent string provided by that device during the transaction.

Moreover, in some embodiments, training data 410 can be used to train a classifier used for performing device identification. In some embodiments, for example, device identification may be implemented by a classifier based on a probabilistic classification model, such as a naïve Bayes classifier. Accordingly, training data 410 may be used to train the classifier based on past transactions from known devices of a user.

In some embodiments, for example, a device signature can be generated for each past transaction in training data 410 based on the user agent. Based on the resulting device signatures generated from the past transactions, signature transition features can then be defined between corresponding attributes of the known device signatures. A signature transition feature, for example, may identify a transition from an attribute of one known device signature to a corresponding attribute of another known device signature. A probabilistic classification model (e.g., a naïve Bayes classification model) can then be trained using the signature transition features as training input. For example, the classifier may define two classes, a match class and a non-match class, and the classifier may output a match likelihood and a non-match likelihood for each signature transition feature.

For example, with respect to transaction T₁ received from device D₁, a signature is first generated by splitting the user agent “Firefox 32.0” into respective tokens “Firefox” and “32.0”. Since this is the first transaction, the signature for device D₁ is mapped against itself, resulting in signature transition features “Firefox 4 Firefox” and “32.0→32.0”. Moreover, since the respective signatures are both for device D₁, a match is detected, and thus an overall match counter is incremented, along with separate match counters for each signature transition feature.

With respect to transaction T₂ received from device D₂, a signature is first generated by splitting the user agent “Firefox 34.0” into respective tokens “Firefox” and “34.0”.

The prior signature for device D₁ is then mapped against the current signature for device D₂, resulting in signature transition features “Firefox 4 Firefox” and “32.0→34.0”. Since the respective signatures are for different devices, a non-match is detected, and an overall non-match counter is incremented, along with separate non-match counters for each signature transition feature.

The current signature for device D₂ is then mapped against itself, resulting in signature transition features “Firefox 4 Firefox” and “34.0→34.0”. Since the respective signatures are for the same device, a match is detected, and the overall match counter is incremented, along with the match counters for each signature transition feature.

With respect to transaction T₃ received from device D₁, a signature is first generated by splitting the user agent “Firefox 33.0” into respective tokens “Firefox” and “33.0”.

The prior signature for device D₁ is then mapped against the current signature for device D₁, resulting in signature transition features “Firefox 4 Firefox” and “32.0→33.0”. Since the respective signatures are for the same device, a match is detected, and an overall match counter is incremented, along with separate match counters for each signature transition feature.

The prior signature for device D₂ is then mapped against the current signature for device D₁, resulting in signature transition features “Firefox 4 Firefox” and “34.0→33.0”. Since the respective signatures are for different devices, a non-match is detected, and the overall non-match counter is incremented, along with the non-match counters for each signature transition feature.

With respect to transaction T₄ received from device D₃, a signature is first generated by splitting the user agent “Firefox 32.0” into respective tokens “Firefox” and “32.0”.

The prior signature for device D₁ is then mapped against the current signature for device D₃, resulting in signature transition features “Firefox 4 Firefox” and “33.0→32.0”. Since the respective signatures are for different devices, a non-match is detected, and an overall non-match counter is incremented, along with separate non-match counters for each signature transition feature.

The prior signature for device D₂ is then mapped against the current signature for device D₃, resulting in signature transition features “Firefox 4 Firefox” and “34.0→32.0”. Since the respective signatures are for different devices, a non-match is detected, and the overall non-match counter is incremented, along with the non-match counters for each signature transition feature.

The current signature for device D₃ is then mapped against itself, resulting in signature transition features “Firefox 4 Firefox” and “32.0→32.0”. Since the respective signatures are for the same device, a match is detected, and the overall match counter is incremented, along with the match counters for each signature transition feature.

With respect to transaction T₅ received from device D₁, a signature is first generated by splitting the user agent “Firefox 34.0” into respective tokens “Firefox” and “34.0”.

The prior signature for device D₁ is then mapped against the current signature for device D₁, resulting in signature transition features “Firefox 4 Firefox” and “33.0→34.0”. Since the respective signatures are for the same device, a match is detected, and an overall match counter is incremented, along with separate match counters for each signature transition feature.

The prior signature for device D₂ is then mapped against the current signature for device D₁, resulting in signature transition features “Firefox 4 Firefox” and “34.0→34.0”. Since the respective signatures are for different devices, a non-match is detected, and the overall non-match counter is incremented, along with the non-match counters for each signature transition feature.

The prior signature for device D₃ is then mapped against the current signature for device D₁, resulting in signature transition features “Firefox 4 Firefox” and “32.0→34.0”. Since the respective signatures are for different devices, a non-match is detected, and the overall non-match counter is incremented, along with the non-match counters for each signature transition feature.

With respect to transaction T₆ received from device D₁, a signature is first generated by splitting the user agent “Firefox 35.0” into respective tokens “Firefox” and “35.0”.

The prior signature for device D₁ is then mapped against the current signature for device D₁, resulting in signature transition features “Firefox 4 Firefox” and “34.0→35.0”. Since the respective signatures are for the same device, a match is detected, and an overall match counter is incremented, along with separate match counters for each signature transition feature.

The prior signature for device D₂ is then mapped against the current signature for device D₁, resulting in signature transition features “Firefox 4 Firefox” and “34.0→35.0”. Since the respective signatures are for different devices, a non-match is detected, and the overall non-match counter is incremented, along with the non-match counters for each signature transition feature.

The prior signature for device D₃ is then mapped against the current signature for device D₁, resulting in signature transition features “Firefox 4 Firefox” and “32.0→35.0”. Since the respective signatures are for different devices, a non-match is detected, and the overall non-match counter is incremented, along with the non-match counters for each signature transition feature.

After the training data has been processed, the resulting counter values can be used to identify the post-training likelihoods shown in FIG. 4B, and the prior probabilities shown in FIG. 4C.

For example, based on the match and non-match counters for the signature transition features, a match and non-match likelihood can be identified for each feature, where each counter is used as the numerator of a ratio and the sum of all match or non-match counters is used as a denominator. These resulting post-training likelihoods 420 are shown in FIG. 4B:

POST-TRAINING LIKELIHOODS

| Feature | Match Likelihood | Non-Match Likelihood |
|---|---|---|
| Firefox → Firefox | 6/12 | 8/16 |
| 32.0 → 32.0 | 2/12 | 0/16 |
| 32.0 → 34.0 | 0/12 | 2/16 |
| 34.0 → 34.0 | 1/12 | 1/16 |
| 32.0 → 33.0 | 1/12 | 0/16 |
| 34.0 → 33.0 | 0/12 | 1/16 |
| 34.0 → 32.0 | 0/12 | 1/16 |
| 33.0 → 32.0 | 0/12 | 1/16 |
| 33.0 → 34.0 | 1/12 | 0/16 |
| 34.0 → 35.0 | 1/12 | 1/16 |
| 32.0 → 35.0 | 0/12 | 1/16 |

Moreover, based on the overall match and non-match counters, a match and non-match prior probability can be identified, where each counter is used as the numerator of a ratio and the sum of both counters is used as the denominator. These resulting prior probabilities 430 are shown in FIG. 4C:

PRIORS

| Match | Non-Match |
|---|---|
| 6/14 | 8/14 |

Once the training process is complete, the classifier may then be used to determine whether subsequent transactions from unidentified devices of the user are originating from any of the known devices D₁-D₃. For example, FIG. 4D illustrates example data 440 associated with a new incoming transaction T₇ from an unidentified device of the user:

INCOMING TRANSACTION

| Transaction | Device | User Agent |
|---|---|---|
| T₇ | ?? | Firefox 33.0 |

In order to determine whether incoming transaction T₇ originated from any of known devices D₁-D₃, a device signature is first generated for the incoming transaction based on the user agent. Next, as shown in FIGS. 4E, 4F, and 4G, the classifier may then compute device match probabilities for known devices D₁-D₃ by computing a Bayesian match posterior for each known device.

FIG. 4E illustrates the match posterior calculation 450 for device D₁:

POSTERIOR: DEVICE D₁

| Feature | Match Likelihood | Non-Match Likelihood |
|---|---|---|
| Firefox → Firefox | 7/13 | 9/17 |
| 35.0 → 33.0 | 1/13 | 1/17 |

$$Match Posterior = \frac{( \frac{6}{14} ) ( \frac{7}{13} ) ( \frac{1}{13} )}{[ ( \frac{6}{14} ) ( \frac{7}{13} ) ( \frac{1}{13} ) + ( \frac{8}{14} ) ( \frac{9}{17} ) ( \frac{1}{17} ) ]} = 0.4994$$

First, the prior signature for device D₁ is mapped against the signature for the unidentified device, resulting in signature transition features “Firefox 4 Firefox” and “35.0 4 33.0”.

Next, the match and non-match likelihoods for these signature transition features are obtained from the post-training likelihoods 420 of FIG. 4B, and a Laplacian correction is applied by incrementing each numerator and denominator by 1 in order to avoid probabilities of zero.

For example, with respect to the signature transition feature “Firefox 4 Firefox”, the match and non-match likelihoods of 6/12 and 8/16 are respectively incremented to 7/13 and 9/17 based on the Laplacian correction.

The signature transition feature “35.0→33.0” was not encountered during training, however, and thus its match and non-match likelihoods would normally be 0/12 and 0/16, but instead they are incremented to 1/13 and 1/17 based on the Laplacian correction.

A Bayesian match posterior for device D₁ can then be computed as shown by the formula above, using the adjusted match and non-match likelihoods, along with the match and non-match priors 430 from FIG. 4C. A similar approach can be used to compute the match posteriors for devices D₂ and D₃, as shown below.

FIG. 4F illustrates the match posterior calculation 460 for device D₂:

POSTERIOR: DEVICE D₂

| Feature | Match Likelihood | Non-Match Likelihood |
|---|---|---|
| Firefox → Firefox | 7/13 | 9/17 |
| 34.0 → 33.0 | 1/13 | 1/17 |

$$Match Posterior = \frac{( \frac{6}{14} ) ( \frac{7}{13} ) ( \frac{1}{13} )}{[ ( \frac{6}{14} ) ( \frac{7}{13} ) ( \frac{1}{13} ) + ( \frac{8}{14} ) ( \frac{9}{17} ) ( \frac{1}{17} ) ]} = 0.4994$$

FIG. 4G illustrates the match posterior calculation 470 for device D₃:

POSTERIOR: DEVICE D₃

| Feature | Match Likelihood | Non-Match Likelihood |
|---|---|---|
| Firefox → Firefox | 7/13 | 9/17 |
| 32.0 → 33.0 | 2/13 | 1/17 |

$$Matched Posterior = \frac{( \frac{6}{14} ) ( \frac{7}{13} ) ( \frac{2}{13} )}{[ ( \frac{6}{14} ) ( \frac{7}{13} ) ( \frac{2}{13} ) + ( \frac{8}{14} ) ( \frac{9}{17} ) ( \frac{1}{17} ) ]} = 0.6661$$

FIG. 4H illustrates the resulting match posteriors 480 computed for known devices D₁-D₃:

MATCH POSTERIORS

| Device | Match Posterior |
|---|---|
| D₁ | 0.4994 |
| D₂ | 0.4994 |
| D₃ | 0.6661 |

The resulting match posteriors 480 may then be used as device match probabilities for known devices D₁-D₃. For example, each match posterior 480 may indicate a probability of whether incoming transaction T₇ originated from a particular known device D₁-D₃. In this manner, the known device D₁-D₃ with the highest match posterior 480 is the closest match with respect to transaction T₇, which is known device D₃ in this example.

Accordingly, in some embodiments, it may be assumed that incoming transaction T₇ originated from known device D₃. Alternatively, the match posterior for device D₃ may first be compared to a threshold. If the match posterior for device D₃ exceeds the threshold, then it may be assumed that incoming transaction T₇ originated from known device D₃. If the match posterior for device D₃ is below the threshold, however, then it may be assumed that incoming transaction T₇ originated from a new or unknown device rather than any of the known devices D₁-D₃.

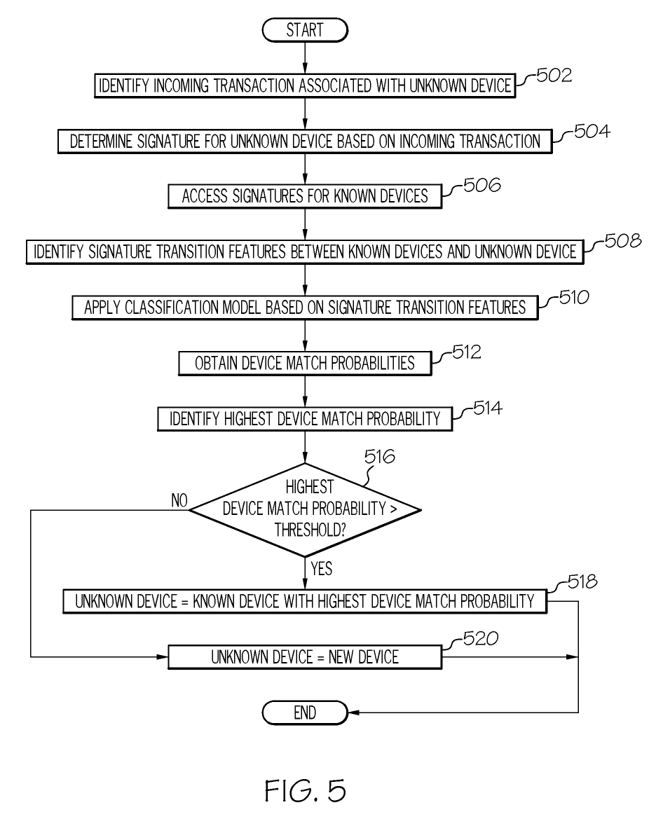

FIG. 5 illustrates a flowchart 500 for an example embodiment of device identification. In some embodiments, flowchart 500 may be implemented using the embodiments and functionality described throughout this disclosure (e.g., computing system 100 of FIG. 1 and/or device identification system 200 of FIG. 2).

The flowchart may begin at block 502 by identifying an incoming transaction associated with an unknown or unverified device of a user.

The flowchart may then proceed to block 504 to determine a device signature or fingerprint for the unknown device based on the incoming transaction. The device signature may be generated based on a plurality of attributes associated with the unknown device, which may be derived from the incoming transaction. In some embodiments, for example, the device signature may be generated based on the user agent of the unknown device, as specified in the incoming transaction. For example, in some embodiments, the user agent may be tokenized into a plurality of device attributes (e.g., by splitting the user agent string based on certain characters, such as whitespaces and slashes). Moreover, in some cases, device attributes from the user agent that contain version numbers may be further tokenized into a plurality of bigrams (e.g., for version numbers with more than two version number components). Finally, the user agent tokens may be stored in a token vector, which may be used to represent the device signature for the unknown device.

The flowchart may then proceed to block 506 to access signatures for known devices of the user. In some embodiments, for example, signatures for known devices of the user may be generated and stored based on past transactions of the user.

The flowchart may then proceed to block 508 to identify signature transition features between the signatures of the known devices and the unknown device. For example, each signature transition feature may identify a transition from an attribute of a known device signature to a corresponding attribute of the unknown device signature. Moreover, in some embodiments, the signature transition features may be stored in a feature vector.

The flowchart may then proceed to block 510 to apply a classification model to the signature transition features between the known devices and the unknown device.

In some embodiments, for example, device identification may be implemented using a classification model trained to recognize devices based on device signatures and associated signature transition features. The classification model, for example, may be implemented using a probabilistic classifier, such as a naïve Bayes classifier, or any other standard classifier. Moreover, the classification model may be trained for device identification based on the signatures generated for known devices of the user from past transactions. For example, based on the known device signatures, signature transition features can be defined between corresponding attributes of the known device signatures. Each of these signature transition features, for example, may identify a transition from an attribute of one known device signature to a corresponding attribute of another known device signature. The probabilistic classification model can then be trained using these signature transition features as training input. For example, a classifier may define two classes, a match class and a non-match class, and the classifier may determine a match likelihood and a non-match likelihood for each signature transition feature. The classifier may also determine a prior probability for both the match class and the non-match class.

After the training stage is complete, the classification model may be used to probabilistically determine whether the unknown device is one of the known devices of the particular user. For example, the classification model may be applied to the signature transition features between the signatures of the known devices and the unknown device, as identified at block 508.

For example, for each known device, the signature transition features between the particular known device and the unknown device may be identified, and the classification model may be applied to those features to determine a probability indicating whether the unknown device is the particular known device. In some embodiments, for example, the probability may be determined by computing a posterior probability based on (1) a match likelihood and a non-match likelihood for each signature transition feature, and (2) the prior probabilities for the match and non-match classes.

The flowchart may then proceed to block 512 to obtain device match probabilities based on an output of the classification model. In some embodiments, for example, the device match probabilities may correspond to the posterior probabilities computed for each known device at block 510.

The flowchart may then proceed to block 514 to identify the highest device match probability, and the flowchart may proceed to block 516 to determine whether the highest device match probability exceeds a threshold.

If it is determined that the highest device match probability exceeds the threshold, the flowchart may then proceed to block 518, where it is determined that the unknown device is the known device that corresponds to the highest device match probability.

If it is determined that the highest device match probability is below the threshold, however, the flowchart may then proceed to block 520, where it is determined that the unknown device is not any of the known devices and is instead a new device.

At this point, the flowchart may be complete. In some embodiments, however, the flowchart may restart and/or certain blocks may be repeated. For example, in some embodiments, the flowchart may restart at block 502 to continue processing transactions from unknown devices.

It should be appreciated that the flowcharts and block diagrams in the FIGURES illustrate the architecture, functionality, and operation of possible implementations of systems, methods, and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order or alternative orders, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as suited to the particular use contemplated.

1. A method, comprising:
identifying a transaction associated with a first device, wherein an identity of the first device is unverified;
determining, based on the transaction, a first device signature for the first device, wherein the first device signature is based on a plurality of attributes associated with the first device;
accessing a plurality of known device signatures associated with a plurality of known devices;
identifying a plurality of signature transition features between the plurality of known device signatures and the first device signature, wherein each signature transition feature comprises a transition from an attribute of a known device signature to a corresponding attribute of the first device signature;
applying a classification model to the plurality of signature transition features, wherein the classification model has been trained based on the plurality of known device signatures;
obtaining, based on an output of the classification model, a plurality of device match probabilities indicating whether the first device is one of the plurality of known devices; and
determining the identity of the first device based on the plurality of device match probabilities.

2. The method of claim 1, wherein determining, based on the transaction, the first device signature for the first device comprises:
identifying, based on the transaction, a user agent associated with the first device;
tokenizing the user agent into a plurality of tokens, wherein the plurality of tokens corresponds to the plurality of attributes associated with the first device; and
storing the plurality of tokens in a token vector, wherein the token vector is used to represent the first device signature.

3. The method of claim 2, wherein tokenizing the user agent into the plurality of tokens comprises:
identifying a token comprising a version number, wherein the token is identified from the plurality of tokens; and
tokenizing the version number into a plurality of bigrams.

4. The method of claim 1, wherein determining the identity of the first device based on the plurality of device match probabilities comprises:
identifying a highest device match probability of the plurality of device match probabilities; and
identifying a known device corresponding to the highest device match probability, wherein the known device is identified from the plurality of known devices.

5. The method of claim 4, wherein determining the identity of the first device based on the plurality of device match probabilities further comprises:
determining that the first device is the known device corresponding to the highest device match probability, wherein a difference between the first device signature for the first device and a known device signature for the known device is based on a software upgrade.

6. The method of claim 4, wherein determining the identity of the first device based on the plurality of device match probabilities further comprises:
determining that the highest device match probability exceeds a threshold; and
determining that the first device is the known device corresponding to the highest device match probability based at least in part on the highest device match probability exceeding the threshold.

7. The method of claim 4, wherein determining the identity of the first device based on the plurality of device match probabilities further comprises:
determining that the highest device match probability is below a threshold; and
determining that the first device is not one of the plurality of known devices based at least in part on the highest device match probability falling below the threshold.

8. The method of claim 1, wherein applying the classification model to the plurality of signature transition features comprises:
for each known device of the plurality of known devices:
identifying a known device signature for a particular known device;
identifying a subset of signature transition features, wherein the subset of signature transition features comprises the plurality of signature transition features between the known device signature and the first device signature;
applying the classification model to the subset of signature transition features; and
outputting a probability indicating whether the first device is the particular known device.

9. The method of claim 8, wherein applying the classification model to the subset of signature transition features comprises:
identifying a match likelihood and a non-match likelihood for each signature transition feature of the subset of signature transition features; and
computing, based on the match likelihood and the non-match likelihood for each signature transition feature, the probability indicating whether the first device is the particular known device.

10. The method of claim 1, further comprising training the classification model based on the plurality of known device signatures.

11. The method of claim 10, wherein training the classification model based on the plurality of known device signatures comprises:
identifying a second plurality of signature transition features between corresponding attributes of the plurality of known device signatures; and
determining a match likelihood and a non-match likelihood for each signature transition feature of the second plurality of signature transition features.

12. The method of claim 1, wherein the classification model comprises a naive Bayes classification model.

13. A non-transitory computer readable medium having program instructions stored therein, wherein the program instructions are executable by a computer system to perform operations comprising:
identifying a transaction associated with a first device, wherein an identity of the first device is unverified;
identifying, based on the transaction, a user agent associated with the first device;
determining, based on the user agent, a first device signature for the first device;
accessing a plurality of known device signatures associated with a plurality of known devices;
identifying a plurality of signature transition features between the plurality of known device signatures and the first device signature, wherein each signature transition feature comprises a transition from an attribute of a known device signature to a corresponding attribute of the first device signature;
applying a classification model to the plurality of signature transition features, wherein the classification model has been trained based on the plurality of known device signatures;
obtaining, based on an output of the classification model, a plurality of device match probabilities indicating whether the first device is one of the plurality of known devices; and
determining the identity of the first device based on the plurality of device match probabilities.

14. A system, comprising:
a processing device;
a memory; and
a device identification engine stored in the memory, the device identification engine executable by the processing device to:
identify a transaction associated with a first device, wherein an identity of the first device is unverified;
determine, based on the transaction, a first device signature for the first device, wherein the first device signature is based on a plurality of attributes associated with the first device;
access a plurality of known device signatures associated with a plurality of known devices;
identify a plurality of signature transition features between the plurality of known device signatures and the first device signature, wherein each signature transition feature comprises a transition from an attribute of a known device signature to a corresponding attribute of the first device signature;
apply a classification model to the plurality of signature transition features, wherein the classification model has been trained based on the plurality of known device signatures;
obtain, based on an output of the classification model, a plurality of device match probabilities indicating whether the first device is one of the plurality of known devices; and
determine the identity of the first device based on the plurality of device match probabilities.

15. The system of claim 14, wherein the device identification engine executable by the processing device to determine, based on the transaction, the first device signature for the first device is further executable to:
identify, based on the transaction, a user agent associated with the first device;
tokenize the user agent into a plurality of tokens, wherein the plurality of tokens corresponds to the plurality of attributes associated with the first device; and
store the plurality of tokens in a token vector, wherein the token vector is used to represent the first device signature.

16. The system of claim 15, wherein the device identification engine executable by the processing device to tokenize the user agent into the plurality of tokens is further executable to:
identify a token comprising a version number, wherein the token is identified from the plurality of tokens; and
tokenize the version number into a plurality of bigrams.

17. The system of claim 14, wherein the device identification engine executable by the processing device to determine the identity of the first device based on the plurality of device match probabilities is further executable to:
identify a highest device match probability of the plurality of device match probabilities;
identify a known device corresponding to the highest device match probability, wherein the known device is identified from the plurality of known devices; and
determine that the first device is the known device corresponding to the highest device match probability.

18. The system of claim 14, wherein the device identification engine executable by the processing device to apply the classification model to the plurality of signature transition features is further executable to:
for each known device of the plurality of known devices:
identify a known device signature for a particular known device;
identify a subset of signature transition features, wherein the subset of signature transition features comprises the plurality of signature transition features between the known device signature and the first device signature;
apply the classification model to the subset of signature transition features; and
output a probability indicating whether the first device is the particular known device.

19. The system of claim 18, wherein the device identification engine executable by the processing device to apply the classification model to the subset of signature transition features is further executable to:
identify a match likelihood and a non-match likelihood for each signature transition feature of the subset of signature transition features; and
compute, based on the match likelihood and the non-match likelihood for each signature transition feature, the probability indicating whether the first device is the particular known device.

20. The system of claim 14, wherein the device identification engine is further executable by the processing device to:
train the classification model based on the plurality of known device signatures;
identify a second plurality of signature transition features between corresponding attributes of the plurality of known device signatures; and
determine a match likelihood and a non-match likelihood for each signature transition feature of the second plurality of signature transition features.
